(19) United States
(12) Patent Application Publication
(10) Pub. No.: US 2024/0420012 A1
(43) Pub. Date: Dec. 19, 2024

(54) SYSTEMS AND METHODS FOR INTEROPERABLE GENERATIVE ARTIFICIAL INTELLIGENCE (AI) ORCHESTRATION

(71) Applicant: AT&T Intellectual Property I, L.P., Atlanta, GA (US)

(72) Inventors: Mark Austin, Lucas, TX (US); Abhay Dabholkar, Allen, TX (US); Brian Nab, Allen, TX (US); Andrew Markus, Alpharetta, GA (US)

(73) Assignee: AT&T Intellectual Property I, L.P., Atlanta, GA (US)

(21) Appl. No.: 18/334,481

(22) Filed: Jun. 14, 2023

(51) Int. Cl. G06N 20/00

(52) U.S. Cl. CPC G06N 20/00

(57) ABSTRACT

Aspects of the subject disclosure may include, for example, obtaining one or more information items or documents, checking the one or more information items or documents for determined sensitivity and determining role-based access for the one or more information items or documents, based on the checking and the determining, performing a preliminary analysis of the one or more information items or documents, wherein the preliminary analysis involves one or more pre-processing procedures, one or more chunking procedures, one or more embedding procedures, one or more customization procedures for particular use cases, or a combination thereof, and storing results of the preliminary analysis in a vector knowledge base for training one or more generative artificial intelligence (AI) large language models (LLMs). Other embodiments are disclosed.

### FIELD OF THE DISCLOSURE

The subject disclosure relates to interoperable generative AI orchestration.

### BACKGROUND

Generative AI platforms, such as OpenAI's ChatGPT (which holds the record for the fastest adopted consumer platform—i.e., about 100 million users in one month), have enabled the average person to directly obtain answers to questions rather than reading through a ranked list of search results for answers. These platforms have also unlocked amazing use cases: summarizing a document, classifying a transcript according to a list of categories, translating text/code from one language to another, and many more. OpenAI's ChatGPT has released an application programming interface (API) that allows others to build applications on top of it. A consumable generative AI API is also common in other generative AI platforms, such as Google's Bard, Meta's large language models (LLMs), some Hugging Face models, Nvidia's models, and others.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting environment for generative AI orchestration in accordance with various aspects described herein.

FIG. 2A is a flow diagram illustrating an example, non-limiting embodiment of knowledge creation orchestration by the generative AI orchestration platform of FIG. 1 in accordance with various aspects described herein.

FIG. 2B is a flow diagram illustrating an example, non-limiting embodiment of query orchestration by the generative AI orchestration platform of FIG. 1 in accordance with various aspects described herein.

FIG. 2C is a flow diagram illustrating an example, non-limiting embodiment of query response orchestration in relation to FIG. 2B in accordance with various aspects described herein.

FIG. 2D is a flow diagram illustrating an example, non-limiting embodiment of reinforcement learning with human feedback (RLHF)-based response orchestration in relation to FIG. 2B in accordance with various aspects described herein.

FIG. 2E illustrates example, non-limiting user flows of a generative AI orchestration platform in accordance with various aspects described herein.

FIG. 2F depicts an illustrative embodiment of a method in accordance with various aspects described herein.

FIG. 2G depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

While existing generative AI platform APIs may allow for easy access, they present several problems for corporations or enterprises that would like to use them.

First, there is generally no privacy protection on the input. In particular, any user can paste or submit, intentionally or unintentionally, sensitive personal information (e.g., name, age, phone number, social security number, etc.) or financial information (e.g., credit card numbers, bank account numbers, etc.) into the chatbot. For example, the current OpenAI platform stores such information for some period of time, which allows for potential leakage. Worse yet, since the LLM is periodically updated with information that users share with it, some amount of this information can make its way into the outputs shared with other users on their subsequent questions.

Second, there are limitations on recent knowledge. That is, answers provided by existing AI platforms are only available based on public knowledge that is up to a given date. The current version of ChatGPT, for instance, is trained on knowledge through 2021. Hence, it is generally unaware of more recent knowledge and it is generally unaware of information that a corporation or enterprise would like to share internally.

Third, existing AI platforms have incomplete knowledge domains. Accurate answers may depend on a given topic. Models may have more training content in some area versus others that are used to answer questions. The platform may thus “know” a great deal about some subjects and less about others.

Fourth, there is generally no protection against hallucination—i.e., where an out-of-the-box LLM would attempt to generate an answer even if it does not know the answer for sure. Early versions would give wrong dates for historical events. Or, when asked for a reference for topic ‘abc,’ the model would often make up a uniform resource locator (URL) for it, such as “see abc.com.”

Fifth, existing AI platforms are not suitable for answering questions relating to proprietary information. As mentioned above, existing platforms are generally unaware of proprietary information unless an extensive document store is built around the API. Also, role-based access controls generally do not exist to permit only certain users to ask questions about certain information. For instance, a company may desire some documents (e.g., human resources (HR) documents, customer care documents, product offerings documents, etc.) to be open/accessible to some or all users and other documents (e.g., relating to employee-specific information, non-disclosure agreement (NDA)-related projects, etc.) to be protected from certain users. In cases where some form of role-based access control is implemented, there is generally overprotection risk where some users may not be provided an answer that they should have been. That is, users that otherwise are authorized to access certain information can be restricted therefrom by the AI platform and thus would not be provided the appropriate answers to their questions. Further, there may be cases where some form of role-based access was configured with undesired over-prescription such that answer discovery is not permitted, which unnecessarily limits productivity.

Sixth, there is generally no interoperability across different models. Any solution based on a given API, whether built on the LLM of OpenAI, Google, Meta, Nvidia, or others, is generally not out-of-the box interoperable/interchangeable. An enterprise system that seeks to use generative AI should be configured for plug-and-play with different models for cost and performance reasons (updates are often and fast in this technological area). Additionally, solutions built around existing APIs can have a variety of components. Depending on the use case, different APIs may be used for some document pipelines while simple no-cost private LLMs can be used for others.

Seventh, there are generally no legal, privacy, and/or ethical/bias checks on the output. Any solution that a company or enterprise would like to evaluate needs to have some checks on the outputs to protect against legal, privacy, and ethical/bias issues. This means that organizations would need to build a custom solution in order to address these concerns.

Finally, there are generally no controls on user feedback loops. Ideally, it would be useful to allow a company or enterprise to collect feedback from its users and decide which feedback ought to be accepted or rejected for improving the completeness or accuracy of the model's answers.

The subject disclosure describes, among other things, illustrative embodiments of an interoperable generative AI orchestration platform (or system) that solves all of the aforementioned problems. In exemplary embodiments, the orchestration platform may be an intelligent system that is capable of high-accuracy document/data understanding or analysis and that provides for role-/need-based security (e.g., “safe-for-use” in a legal/ethical sense) as well as “maximum discoverability” of content. Existing generative AI platforms typically surface content from existing documents (e.g., summaries, variations, classifications, etc.) and generate new documents (e.g., answers) based on the guidance of a user prompt. However, these existing systems generally lack security of information sent or generated. In various embodiments, the orchestration platform described herein advantageously provides security for both the input (e.g., user prompts) and the output by using role-based access control to determine what content can be accessed in the retrieval process for generating answers. This is particularly useful for enterprises where only certain groups of individuals should have access to certain information. Further, since “answers” may exist across multiple document/data sets, the interoperable orchestration platform incorporates maximum discoverability, where it can suggest access recommendations and/or provide recommendations for what content should automatically be made available to certain sets of users.

While generic foundational models may perform satisfactorily in generating answers, more custom-tuned models or pipelines can outperform the generic approach. In one or more embodiments, the orchestration platform may be configured for democratization of development with high accuracy. More particularly, the interoperable orchestration platform may implement methods for democratizing pipelines (e.g., relating to categories of data/documents on which generative AI LLM(s) can be trained and from which answers to user questions can be derived) based on information/document class so as to allow faster development and more accurate system output. In certain embodiments, the orchestration platform provides for a common knowledge base (or vector store) that contains data for different information/document classes as well as various use cases associated with the classes. This democratization allows some or all parts of an enterprise (various users, developers, etc.) to leverage the knowledge base for their individual usage. Various aspects of the orchestration platform are described in more detail below.

Embodiments of the orchestration platform facilitate usage of generative AI systems in a safe and democratized manner, with maximum discoverability and high-accuracy data/document understanding. Inadvertent sharing of organizational proprietary information poses serious risks to the sustainability of the organization. Embodiments of the orchestration platform provide for a (e.g., private tenant) hosted solution that protects against information (e.g., intellectual property, etc.) leakage into the public domain. The orchestration platform can safely “teach” LLM(s) at scale about a given enterprise such that enterprise users can safely ask questions and receive safe output responses. It is believed that the orchestration platform described herein provides generative AI-based productivity improvements for an organization (e.g., any company or entity that has private and/or public information that they need to make readily accessible to users, such as employees, managers, and/or customers) that allows it to run more efficiently (e.g., 30-50% more efficiently). It is also believed that tuning enabled by embodiments of the orchestration platform can also drastically improve the accuracy of outputs provided by generative AI LLMs. Aspects of the interoperable orchestration platform may be customized depending on the company/enterprise and for a variety of company/enterprise use cases.

One or more aspects of the subject disclosure include a device, comprising a processing system including a processor, and a memory that stores executable instructions that, when executed by the processing system, facilitate performance of operations. The operations can include obtaining one or more information items or documents. Further, the operations can include checking the one or more information items or documents for determined sensitivity and determining role-based access for the one or more information items or documents. Further, the operations can include, based on the checking and the determining, performing a preliminary analysis of the one or more information items or documents, wherein the preliminary analysis involves one or more pre-processing procedures, one or more chunking procedures, one or more embedding procedures, one or more customization procedures for particular use cases, or a combination thereof. Further, the operations can include storing results of the preliminary analysis in a vector knowledge base for training one or more generative artificial intelligence (AI) large language models (LLMs).

One or more aspects of the subject disclosure include a method. The method can comprise receiving, by a processing system including a processor, a user query, wherein the user query is submitted by an authenticated user or bot, wherein the processing system implements a plurality of processing pipelines for a corresponding plurality of content categories or classes, and wherein the processing system is interoperable with one or more generative artificial intelligence (AI) large language models (LLMs). Further, the method can include, based on the receiving, evaluating, by the processing system, a context of the user query. Further, the method can include causing, by the processing system, the user query to be routed to one or more of the processing pipelines in accordance with the context. Further, the method can include, based on the one or more of the processing pipelines to which the user query is routed, generating, by the processing system, one or more curated LLM prompts for the user query and retrieving, by the processing system, one or more extracts from one or more embeddings associated with information or documents that the one or more generative AI LLMs have been trained on. Further, the method can include combining, by the processing system, the one or more curated LLM prompts and the one or more extracts with the user query, resulting in a modified query. Further, the method can include performing, by the processing system, response generation by submitting the modified query to the one or more generative AI LLMs that correspond to the one or more of the processing pipelines to which the user query has been routed, so as to derive a generated answer to the user query.

One or more aspects of the subject disclosure include a non-transitory machine-readable medium, comprising executable instructions that, when executed by a processing system including a processor, facilitate performance of operations. The operations can include obtaining a user query, wherein the user query is submitted by an authenticated user or bot, wherein the processing system implements a plurality of processing pipelines for a corresponding plurality of content categories or classes, and wherein the processing system is interoperable with one or more generative artificial intelligence (AI) large language models (LLMs). Further, the operations can include, based on the obtaining, evaluating a context of the user query. Further, the operations can include causing the user query to be routed to one or more of the processing pipelines in accordance with the context. Further, the operations can include, based on the one or more of the processing pipelines to which the user query is routed, generating one or more curated LLM prompts for the user query and retrieving one or more extracts from one or more embeddings associated with information or documents that the one or more generative AI LLMs have been trained on. Further, the operations can include combining the one or more curated LLM prompts and the one or more extracts with the user query, resulting in a modified query. Further, the operations can include performing response generation by submitting the modified query to the one or more generative AI LLMs that correspond to the one or more of the processing pipelines to which the user query has been routed, so as to derive a response to the user query.

Other embodiments are described in the subject disclosure.

As outlined above, generative AI APIs or public chatbots, such as ChatGPT, are riddled with problems that limit their usefulness to users, especially in the corporate environment. The following describes example, non-limiting embodiments of an orchestration platform that solves these problems for enterprise users while providing an interoperable approach to leveraging publicly-available LLMs to generate (e.g., conversational) responses.

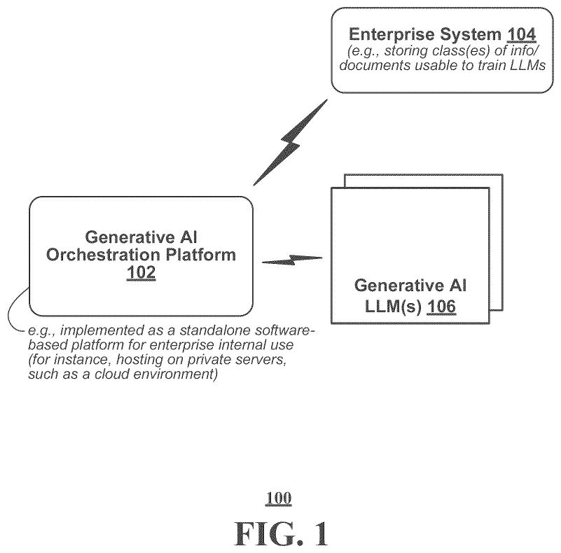

FIG. 1 is a block diagram illustrating an exemplary, non-limiting environment 100 for generative AI orchestration in accordance with various aspects described herein. As shown in FIG. 1, the environment 100 may include a generative AI orchestration platform 102, and enterprise system 104, and one or more generative AI LLMs 106.

The enterprise system 104 may correspond to an enterprise (e.g., any company or entity), and may include one or more computing devices (e.g., servers) that provide or have access to various data, such as one or more classes of information/documents. Example classes of information/documents include, but are not limited to human resources (HR), customer care, product/service, information technology (IT) helpdesk, supply chain, etc.

The generative AI LLM(s) 106 may include one or more large language models that are configured to train on information/documents, intake user questions, and create (e.g., conversational) responses to such questions based on the training. A generative AI LLM may be a publicly-available system (e.g., ChatGPT, Bard, etc.) or a private one developed for internal enterprise usage. In various embodiments, a generative AI LLM may be configured to reduce errors in answer generations. In this way, errors that may be present may be provided as feedback to the LLM, such that the errors may tend to converge toward zero as the LLM is utilized more and more.

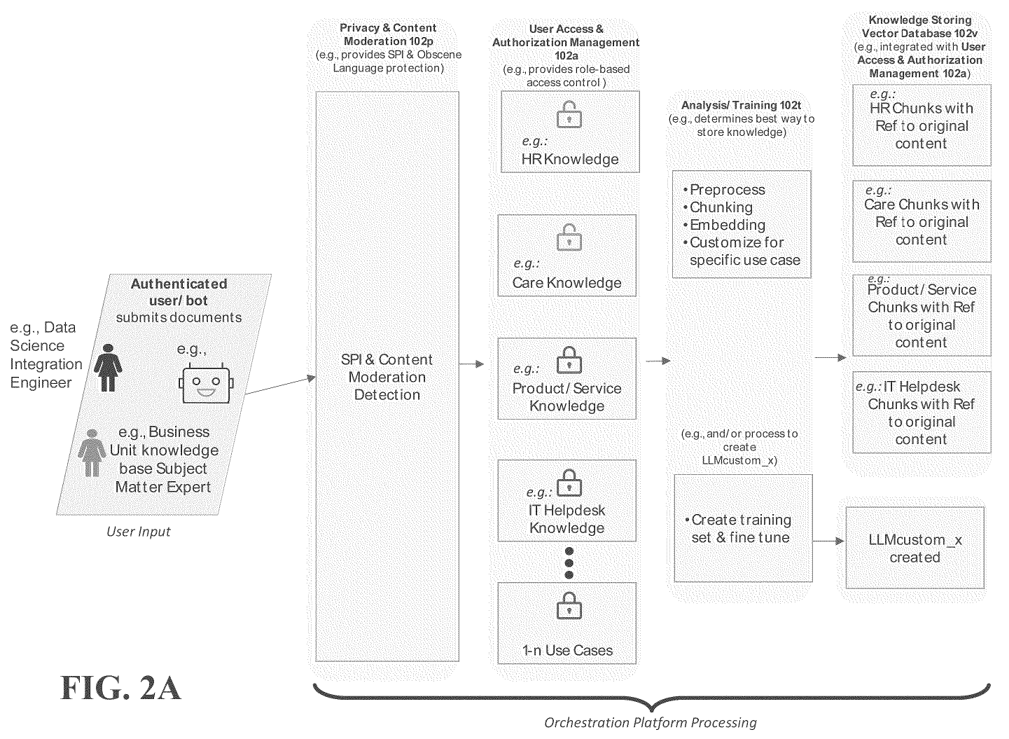

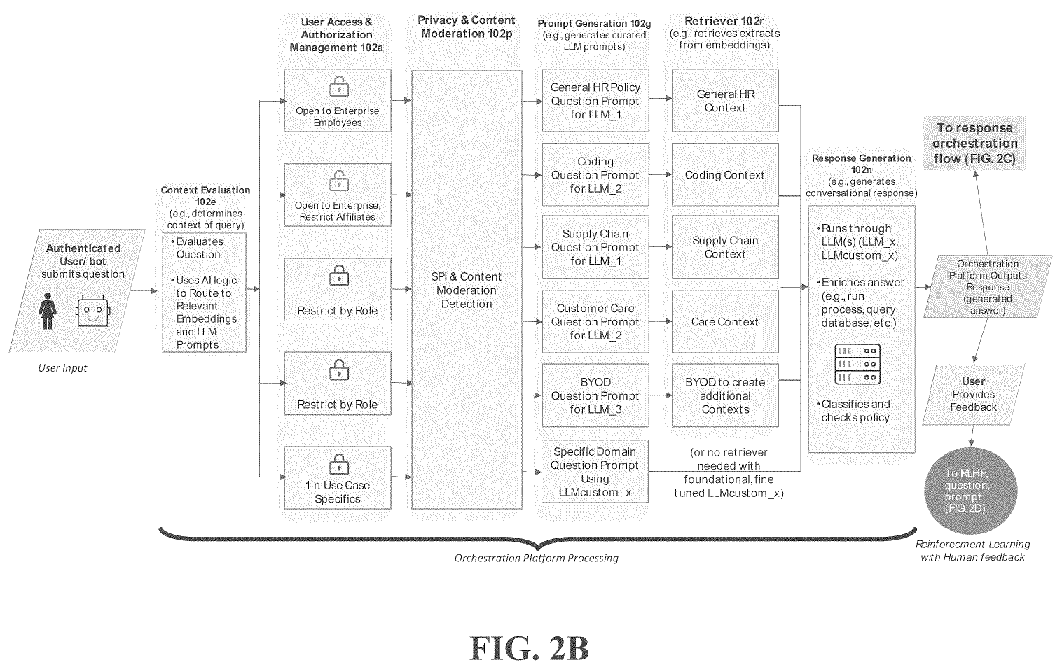

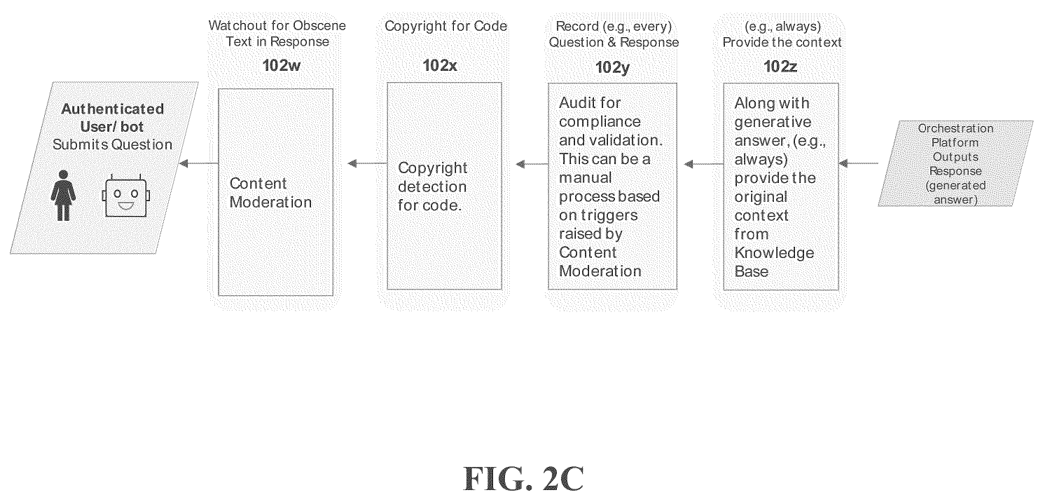

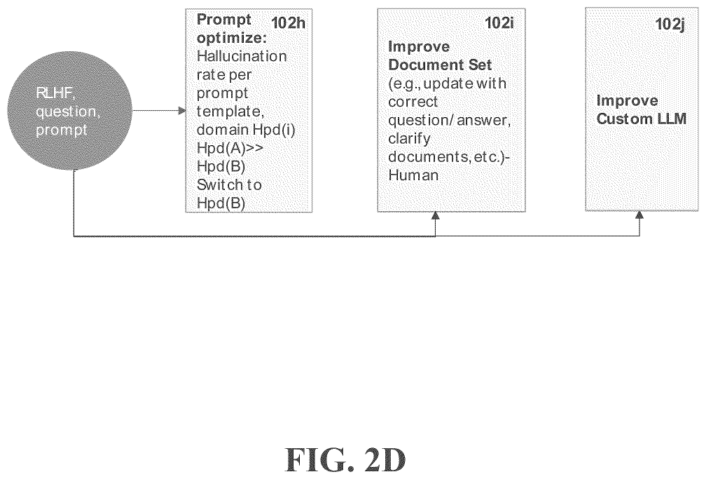

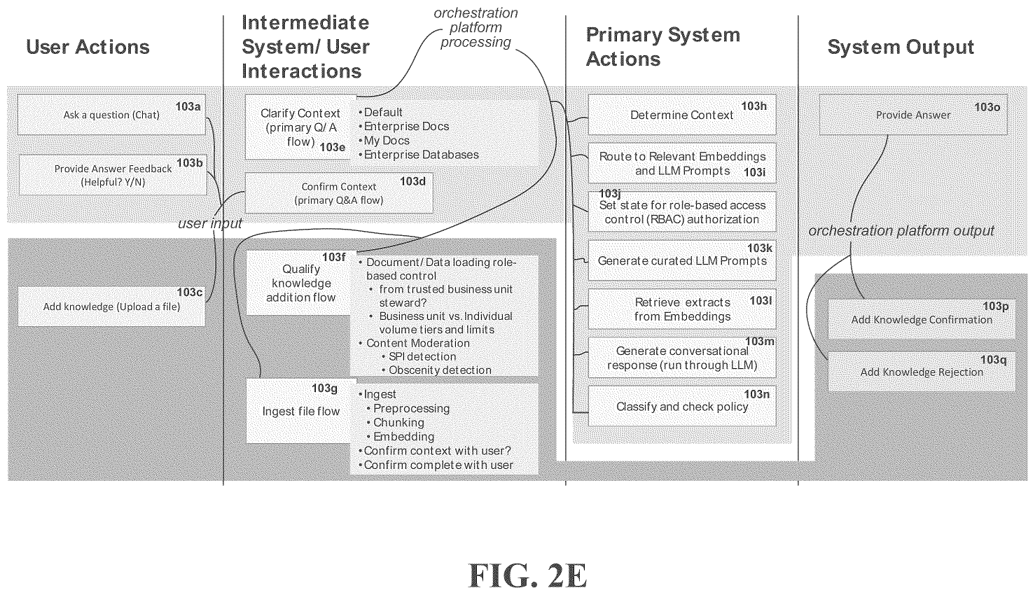

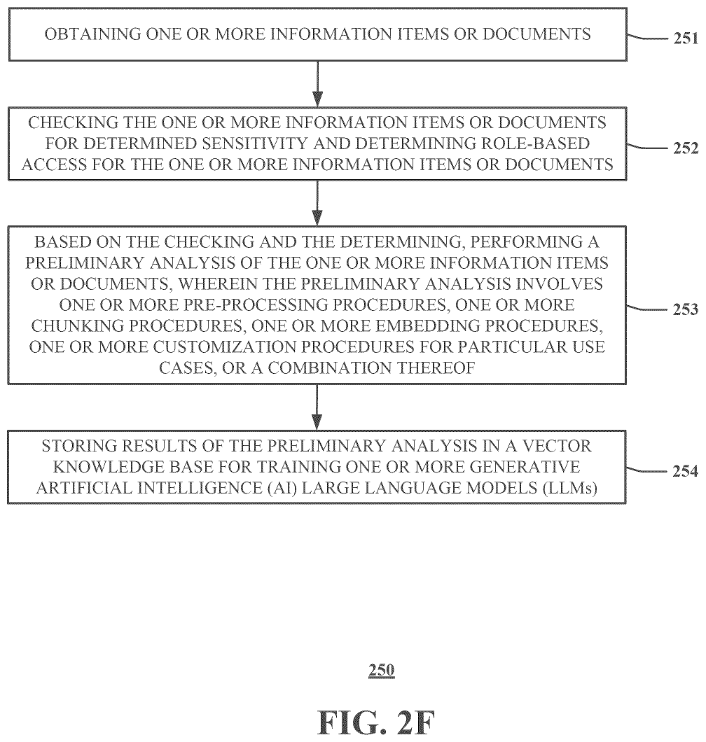

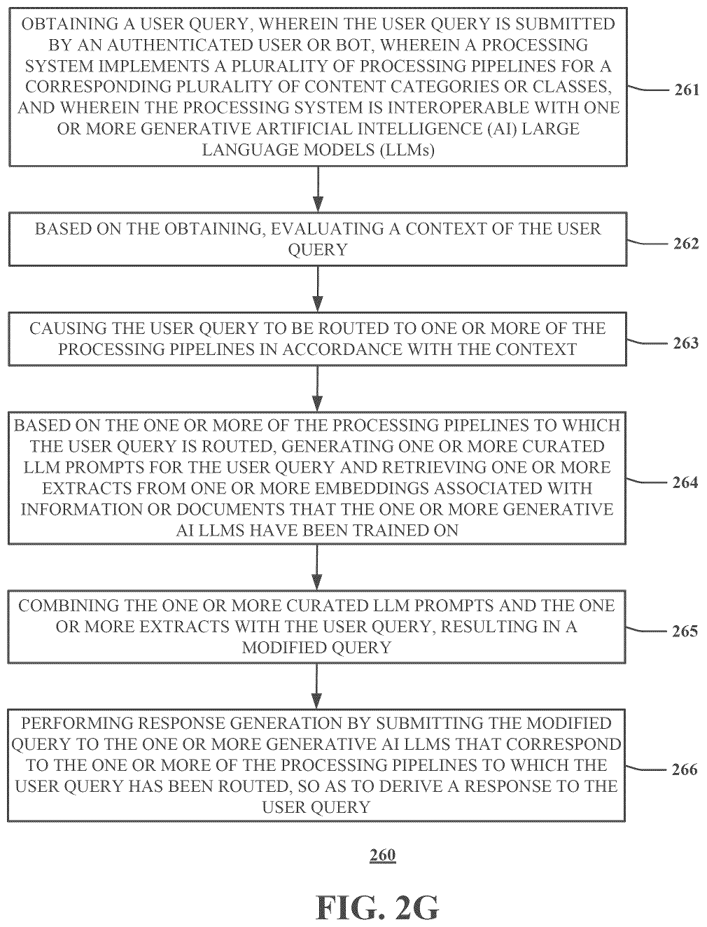

In exemplary embodiments, the orchestration platform 102 may be configured as an intelligent system. As briefly described above, the orchestration platform 102 may be capable of document/data understanding or analysis, may provide for role-/need-based security as well as maximum discoverability of content, and/or may be configured for democratization of development with high accuracy. The orchestration platform 102 may be implemented in software and/or hardware, and may be interoperable with any generative AI LLM, such as some or all of the generative AI LLM(s) 106. In various embodiments, some or all of the functionality of the orchestration platform 102 may be privately hosted (e.g., by the given enterprise), which can ensure that no inputs/outputs are shared externally. Additional details of the orchestration platform 102 are discussed below with respect to one or more of FIGS. 2A-2E.

FIG. 2A is a flow diagram illustrating an example, non-limiting embodiment of knowledge creation orchestration by the generative AI orchestration platform 102 of FIG. 1 in accordance with various aspects described herein. In exemplary embodiments, knowledge creation orchestration may facilitate on-boarding of documents/knowledge to the orchestration platform 102 for training by generative AI LLM(s) 106. As shown in FIG. 2A, knowledge creation orchestration may begin with a user (human) or bot submitting information/documents to the system followed by a sensitive private indicator (SPI) data check by a privacy & content moderation functionality 102p and role-based access control by a user access & authorization management functionality 102a. An SPI check may involve analyzing the information/documents for certain content deemed sensitive (e.g., confidential, proprietary, etc.), such as by performing optical character recognition and searching for certain headings or markers and/or analyzing for certain types of data (e.g., financial data, data relating to minors, and so on). Role-based access control may involve identifying (e.g., based on predefined authorization/access lists or the like) the types of roles (e.g., executives, supervisors, entry-level employees, etc.) that are permitted to access a given piece of information/document.

Subsequently, pre-processing analysis & training 102t may be performed. In certain embodiments, this functionality may determine a suitable (e.g., the best) way to store the knowledge. Various procedures may be involved, including, for instance, pre-processing procedure(s), chunking procedure(s), embedding procedure(s), customization for specific use cases, and/or the like. Some or all of these may be considered “tunable knobs” that a given enterprise may configure or define. For instance, an enterprise may have its own preferred chunking algorithms, embedding algorithms, and so on to “store” knowledge. In any case, the procedures may facilitate accurate similarity matching (later on in response orchestration).

As shown in FIG. 2A, obtained data (e.g., chunks) relating to the various classes or categories of information/documents may be stored in a knowledge base (vector store) 102v. In various embodiments, the vector store 102v may be integrated with the user access & authorization management functionality 102a (“roles-based access control”). In some embodiments, a system developer may be permitted to add or contribute information/documents to the vector store 102v. In certain embodiments, the vector store 102v and/or related functionality may be capable of checking if a submitted document already exists in the store and reject it if so.

Although not shown, in some embodiments, the orchestration platform 102 may include “Bring Your Own Intellectual Property” functionality that allows the enterprise or its users to load proprietary intellectual property (e.g., documents, data, images, videos) to improve the accessible knowledge domain capacity of the overall system. In some cases, documents used for training a question/answer system may have “answers” to questions inside of tables or pictures, and absent a pre-processing system to extract that knowledge specifically, the question and answer system would be blind as to how to obtain this answer. In some embodiments, pre-processing procedure(s) that are capable of analyzing a table or chart for understanding and converting that understanding into text or a standard file format (e.g., JavaScript Object Notation (JSON) or the like) may be used to facilitate the extraction. In certain embodiments, pre-processing procedure(s) that are capable of analyzing an image (e.g., using image recognition technology or the like) for understanding and converting that understanding into text or a standard file format (e.g., JSON or the like) may additionally, or alternatively, be used to facilitate the extraction. In this way, the orchestration platform 102 may address the existing problem where conventional large language question and answer pipelines may not generally understand documents that have “answers” represented in tables or images—i.e., by pre-processing documents and translating tables/images therein into text or a file format such that it is more easily understandable by large language question and answer pipelines.

In some embodiments, analysis/training 102t may be configured to create a predictive custom functionality/language (LLMcustom_x). In various embodiments, an individual LLMcustom_x may be created for generative AI LLM(s) 106 (e.g., each generative AI LLM 106) to be trained. A predictive custom functionality/language may be designed to make predictions based on, or make connections between, content in different classes of information/documents—e.g., the typical next step in a network authentication flow; that geometric rules are needed to solve an engineering design problem, etc. In some cases, a predictive custom functionality/language may be more suitable for smaller scale LLMs that are tunable (i.e., with fewer parameters, such as on the order of billions of parameters or fewer).

FIG. 2B is a flow diagram illustrating an example, non-limiting embodiment of query orchestration by the generative AI orchestration platform 102 of FIG. 1 in accordance with various aspects described herein. FIG. 2C is a flow diagram illustrating an example, non-limiting embodiment of query response orchestration in relation to FIG. 2B in accordance with various aspects described herein. FIG. 2D is a flow diagram illustrating an example, non-limiting embodiment of reinforcement learning with human feedback (RLHF)-based response orchestration in relation to FIG. 2B in accordance with various aspects described herein.

In exemplary embodiments, query orchestration may facilitate answering of a user question using the trained generative AI LLM(s) 106. Referring to FIG. 2B, query orchestration may begin with an authenticated user/bot submitting a question, where context evaluation functionality 102e (“determines context”) examines the question and determines the type of (e.g., private) company documents that may be relevant for generating answers to the question (e.g., if it is an HR question, the context evaluation functionality 102e may select an HR policy path for query traversal).

In various embodiments, the context evaluation functionality 102e may employ AI-based logic that is capable of understanding user questions and determining the path or pipeline (e.g., HR, Supply Chain, etc.) for routing the question. This can determine the ultimate LLM(s) 106 that are accessed to answer the question, how additional instructions are added to LLM prompts, and/or how context is determined.

In certain embodiments, the context evaluation functionality 102e may be capable of selecting multiple pipelines for routing (e.g., HR and Supply Chain policies) such that multiple pipelines are traversed to answer a question. This allows for “access to different knowledge bases” to answer a question that might otherwise be a “combination” type question that relates to different classes or categories of information/documents.

As shown in FIG. 2B, the user access & authorization management functionality 102a (“role-based access control”) may check the authorization level of the authenticated user/bot. Further, a prompt generation functionality 102g (“curated prompt”) may tailor or customize one or more LLM prompts for the question. An LLM prompt may be directed to a particular generative AI LLM 106, and may constitute “additional instructions” on how the question should be asked to the generative AI LLM 106 and/or how the generative AI LLM 106 should answer the question (e.g., tone to be used, if the answer should be written from a perspective of a certain role (such as an executive or entry-level employee), certain details that are to be included in the answer, etc.). In some embodiments, customization of a prompt may be a function of previous questions (e.g., maintaining context for multi-turn questions) and may involve phrasing the question in the context of the relevant company user persona (e.g., employee vs. manager vs. customer). In various embodiments, the orchestration platform 102 may be configured to (e.g., continuously) improve customization of prompts using AI automation. This may involve AI-based evaluation of prompts by testing them on LLM(s) for hallucination.

As shown in FIG. 2B, a retriever functionality 102r (“retrieves extracts from embeddings”) may supplement the customized LLM prompt(s) by retrieving relevant portions of access-controlled (e.g., private) company documents based on the user authorization level identified earlier. This may involve leveraging embeddings indexes (e.g., previously generated by analysis/training functionality 102t of FIG. 2A) to identify particular portions of documents (page, paragraph, etc.) that are likely to correspond to answer(s) to the user's question. Some or all of this identification may be performed using one or more techniques, such as fuzzy logic, natural language processing (NLP), machine learning algorithms, and/or the like. In some embodiments, confirmation of context may be an AI logic-based initial action that requires user confirmation (e.g., the retriever functionality 102r may initially respond to the user with “my initial evaluation of this question is that it has a 70% likelihood of being related to Supply Chain—can you confirm?”). In certain cases, if the determined likelihood satisfies a threshold (e.g., is greater than 75%), the retriever functionality 102r may forgo requesting user confirmation.

Further, a response generation functionality 102n (“generates conversational response”) may obtain the combined prompt and transmit it to the relevant generative AI LLM(s) 106 for generating answer(s). This is the point of interoperability where multiple public/private LLMs may be leveraged.

As shown in FIG. 2B, the generated answer may then be checked against copyright (e.g., for generated answers that include program code), plagiarism, and/or company ethical/bias policies and subsequently provide the answer to the user if checks are passed—e.g., see 102w, 102x, 102y, and 102z of FIG. 2C.

As shown in FIG. 2B, the user may optionally provide feedback regarding the answer, which the system can utilize, in a reinforcement learning with human feedback (RLHF) process to improve future response accuracy—e.g., see 102h, 102i, and 102j of FIG. 2D, where selection of prompt(s) that yield a lower hallucination rate may be determined based on A/B testing, instructions may be added or tuned (e.g., in prompt templates) to more accurately answer the question, corrections may be made to the original document(s) so that they contain the correct answer, and/or adjustments may be made to some or all of the aforementioned predictive custom functionalities/languages. In various embodiments, RLHF feedback may be captured by telemetry and curated as RLHF information for influencing a model's responses. It will be appreciated and understood that the RLFH functionality may be included in the orchestration platform 102, which allows the enterprise to directly make feedback-based improvements.

Earlier above, several problems with existing generative AI systems were discussed. It should be apparent that embodiments of the orchestration platform 102, described herein, advantageously address these problems. More particularly:
Solution to first problem (no privacy protection on the input): When a question is asked, the context evaluation functionality 102e (“determines context”) of the orchestration platform 102 may evaluate the question and determine if the question contains sensitive information. If it does, that portion can be redacted at the outset or the question can be rejected with notification.
Solution to second problem (limitations on recent knowledge): The orchestration platform 102 allows for the addition of new, up-to-date documents. The documents can also be company proprietary and across many different knowledge domains.
Solution to third problem (incomplete knowledge domains): The “Bring Your Own Intellectual Property” aspect of the orchestration platform 102 allows supplemental information to be shared with the system, enabling higher quality and more robust proprietary information to be accessible to users.
Solution to fourth problem (no protection against hallucination): The response generation functionality 102n (“generates conversational response”) may check the output for a given question to ensure that the answer is within the content used for generating the answer.
Solution to fifth problem (not suitable for answering questions on proprietary information): The context evaluation functionality 102e (“determines context”) in combination with the user access & authorization management functionality 102a (“role-based access control”) may facilitate identification of the most relevant document retrieval path to generate an answer to a user's question. For instance, if the question is determined (e.g., by AI logic of the context evaluation functionality 102e) to be an HR-related question, it will be routed to extract content from proprietary HR documents.
   Solution to sub-problem (overprotection risk when role-based access controls are applied): The orchestration platform 102 may provide access recommendation. For instance, if a question is determined to likely to have answer in a pipeline (e.g., Supply Chain) that the user doesn't have access to (e.g., the user is not authorized to access Supply Chain-related documentation), the orchestration platform 102 may detect this and recommend to the user (e.g., as part of responding to the query) to apply for access. In certain embodiments, the orchestration platform 102 may log a list of questions and which roles/users are asking, and may periodically (or based upon one or more conditions being satisfied) review them and generate administrator recommendations as to which roles/users should likely have lessened access restrictions.
Solution to sixth problem (no interoperability across different models): One or more components of the prompt generation functionality 102g (“curated prompt”) and/or the retriever functionality 102r (“retrieves extracts from embeddings”) may be modular and thus enable interoperability. In various embodiments, the response generation functionality 102n (“generates conversational response”) may similarly be modular and thus enable multiple LLMs (e.g., Google's Bard, OpenAI's ChatGPT, etc.) to be configured and/or substituted/swapped out.
Solution to seventh problem (no legal, privacy, ethical/bias checks on the output): Legal, privacy, and ethical/bias checks may be performed by the orchestration layer 102 (e.g., FIG. 2C) before any output is provided. These checks may be performed to respect copyright, avoid plagiarism, and/or comply with company ethical/bias policies before providing an answer.
Solution to eighth problem (no controls on user feedback loops): User feedback on system generated answers may be reviewed by the solution owner. Feedback that is agreed upon (e.g., only feedback deemed to be relevant by an administrator or the like) may be approved to be incorporated in subsequent training for better answers in the future.

FIG. 2E illustrates example, non-limiting user flows of a generative AI orchestration platform in accordance with various aspects described herein. Some or all of the steps or flows shown in FIG. 2E may correspond to features described above with respect to the orchestration platform 102. Alternatively, some or all of the steps or flows shown in FIG. 2E may correspond to another orchestration platform that is similar to the orchestration platform 102. In any case, the flows may involve user actions/inputs (103a, 103b, 103c, 10d), orchestration platform processing (103e, 103f, 103g, 103h, 103i, 103j. 103k, 103l, 103m, 103n), and orchestration platform outputs (103o, 103p, 103q).

It is to be understood and appreciated that the quantity and arrangement of platforms, models, systems, modules/functionalities, and components shown in FIGS. 1 and 2A-2E are provided as an example. In practice, there may be additional platforms, models, systems, modules/functionalities, and/or components, or differently arranged platforms, models, systems, modules/functionalities, and/or components than those shown in FIGS. 1 and 2A-2E. For example, in any of these drawing figures, there may be more or fewer platforms, models, systems, modules/functionalities, and/or components. In practice, therefore, there can be hundreds, thousands, millions, billions, etc. of such platforms, models, systems, modules/functionalities, and/or components. In this way, example systems shown can coordinate, or operate in conjunction with, a set of platforms, models, systems, modules/functionalities, and/or components and/or operate on data sets that cannot be managed manually or objectively by a human actor. Furthermore, two or more platforms, models, systems, modules/functionalities, or components shown in FIGS. 1, 2A, 2B, 2C, 2D, and/or 2E may be implemented within a single platform, model, system, module/functionality, or component, or a single platform, model, system, module/functionality, or component shown in FIGS. 1, 2A, 2B, 2C, 2D, and/or 2E may be implemented as multiple platforms, models, systems, modules/functionalities, or components. Additionally, or alternatively, a set of platforms, models, systems, modules/functionalities, and/or components shown in any of these drawing figures may perform one or more functions described as being performed by another set of platforms, models, systems, modules/functionalities, and/or components shown.

It is also to be understood and appreciated that, although one or more of FIGS. 2A-2E are described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein.

Further, although not shown, one or more networks may be included in environment 100 of FIG. 1 and/or in the systems shown in FIGS. 2A and/or 2B for facilitating communications between any of the systems, users/bots, models, platforms shown. The networks may include one or more wired and/or wireless networks. For example, the networks may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or other types of networks.

It is further to be understood and appreciated that various aspects of interoperable generative AI orchestration described herein do not merely rely on generic computing components for functionality, and that various embodiments of the orchestration platform described herein integrate with AI-based algorithms and thus are necessarily tied to AI technology. Furthermore, embodiments of the orchestration platform solve the various problems described above, and thus provide practical applications in AI technology.

FIG. 2F depicts an illustrative embodiment of a method 250 in accordance with various aspects described herein. In some embodiments, one or more process blocks of FIG. 2F can be performed by an orchestration platform, such as the orchestration platform 102.

At 251, the method can include obtaining one or more information items or documents. For example, the orchestration platform 102 can, similar to that described above with respect to FIG. 2A, perform one or more operations that include obtaining one or more information items or documents.

At 252, the method can include checking the one or more information items or documents for determined sensitivity and determining role-based access for the one or more information items or documents. For example, the orchestration platform 102 can, similar to that described above with respect to FIG. 2A, perform one or more operations that include checking the one or more information items or documents for determined sensitivity and determining role-based access for the one or more information items or documents.

At 253, the method can include, based on the checking and the determining, performing a preliminary analysis of the one or more information items or documents, wherein the preliminary analysis involves one or more pre-processing procedures, one or more chunking procedures, one or more embedding procedures, one or more customization procedures for particular use cases, or a combination thereof. For example, the orchestration platform 102 can, similar to that described above with respect to FIG. 2A, perform one or more operations that include, based on the checking and the determining, performing a preliminary analysis of the one or more information items or documents, wherein the preliminary analysis involves one or more pre-processing procedures, one or more chunking procedures, one or more embedding procedures, one or more customization procedures for particular use cases, or a combination thereof.

At 254, the method can include storing results of the preliminary analysis in a vector knowledge base for training one or more generative artificial intelligence (AI) large language models (LLMs). For example, the orchestration platform 102 can, similar to that described above with respect to FIG. 2A, perform one or more operations that include storing results of the preliminary analysis in a vector knowledge base for training one or more generative artificial intelligence (AI) large language models (LLMs).

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2G depicts an illustrative embodiment of a method 260 in accordance with various aspects described herein. In some embodiments, one or more process blocks of FIG. 2G can be performed by an orchestration platform, such as the orchestration platform 102.

At 261, the method can include obtaining a user query, wherein the user query is submitted by an authenticated user or bot, wherein a processing system implements a plurality of processing pipelines for a corresponding plurality of content categories or classes, and wherein the processing system is interoperable with one or more generative artificial intelligence (AI) large language models (LLMs). For example, the orchestration platform 102 can, similar to that described above with respect to FIG. 2B, perform one or more operations that include obtaining a user query, wherein the user query is submitted by an authenticated user or bot, wherein a processing system implements a plurality of processing pipelines for a corresponding plurality of content categories or classes, and wherein the processing system is interoperable with one or more generative artificial intelligence (AI) large language models (LLMs).

At 262, the method can include, based on the obtaining, evaluating a context of the user query. For example, the orchestration platform 102 can, similar to that described above with respect to FIG. 2B, perform one or more operations that include, based on the obtaining, evaluating a context of the user query.

At 263, the method can include causing the user query to be routed to one or more of the processing pipelines in accordance with the context. For example, the orchestration platform 102 can, similar to that described above with respect to FIG. 2B, perform one or more operations that include causing the user query to be routed to one or more of the processing pipelines in accordance with the context.

At 264, the method can include, based on the one or more of the processing pipelines to which the user query is routed, generating one or more curated LLM prompts for the user query and retrieving one or more extracts from one or more embeddings associated with information or documents that the one or more generative AI LLMs have been trained on. For example, the orchestration platform 102 can, similar to that described above with respect to FIG. 2B, perform one or more operations that include, based on the one or more of the processing pipelines to which the user query is routed, generating one or more curated LLM prompts for the user query and retrieving one or more extracts from one or more embeddings associated with information or documents that the one or more generative AI LLMs have been trained on.

At 265, the method can include combining the one or more curated LLM prompts and the one or more extracts with the user query, resulting in a modified query. For example, the orchestration platform 102 can, similar to that described above with respect to FIG. 2B, perform one or more operations that include combining the one or more curated LLM prompts and the one or more extracts with the user query, resulting in a modified query.

At 266, the method can include performing response generation by submitting the modified query to the one or more generative AI LLMs that correspond to the one or more of the processing pipelines to which the user query has been routed, so as to derive a response to the user query. For example, the orchestration platform 102 can, similar to that described above with respect to FIG. 2B, perform one or more operations that include performing response generation by submitting the modified query to the one or more generative AI LLMs that correspond to the one or more of the processing pipelines to which the user query has been routed, so as to derive a response to the user query.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

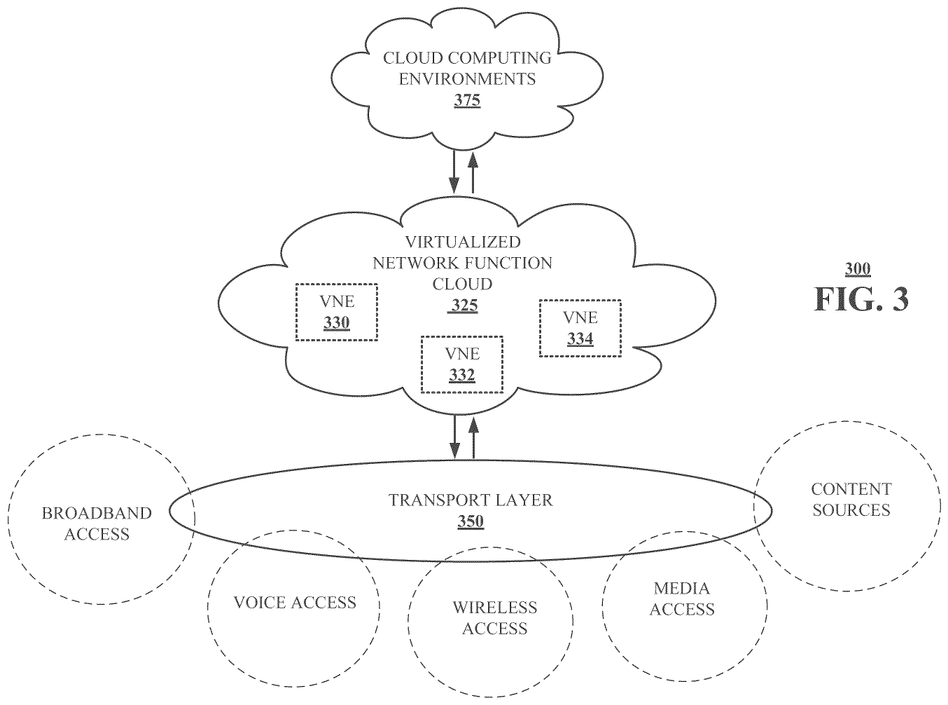

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems, methods, and/or functions presented in FIGS. 1 and 2A-2G. For example, virtualized communications network 300 can facilitate, in whole or in part, interoperable generative AI orchestration.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communications network employs virtual network elements (VNEs) 330, 332, 334, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element, such as an edge router, can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access, wireless access, voice access, media access and/or access to content sources for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers—each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

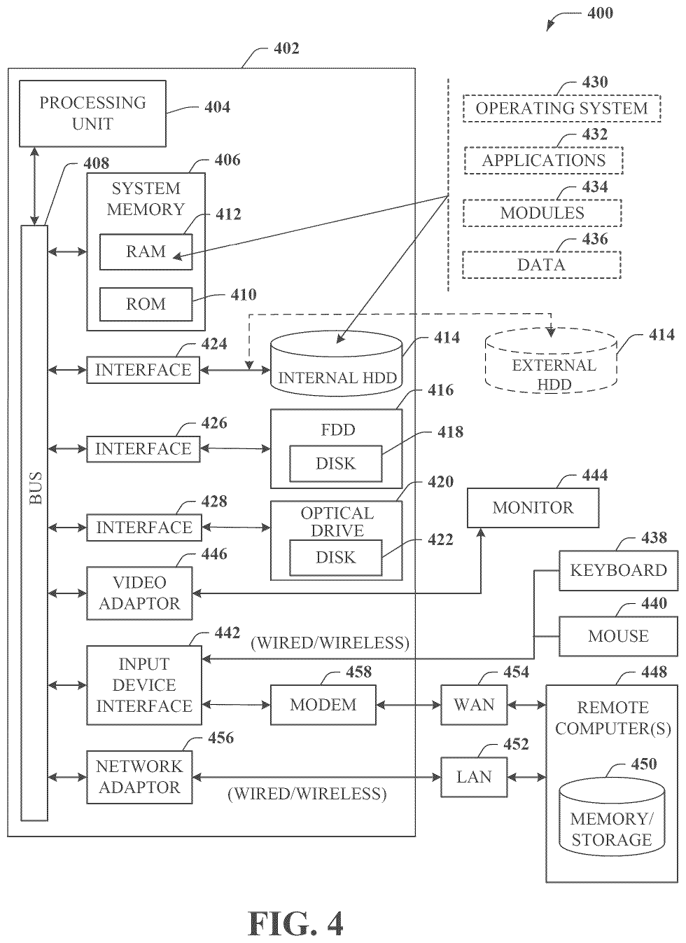

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements, systems, and/or VNEs described herein. Each of these devices can be implemented via computer-executable instructions that can run on one or more computers, and/or in combination with other program modules and/or as a combination of hardware and software. For example, computing environment 400 can facilitate, in whole or in part, interoperable generative AI orchestration.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

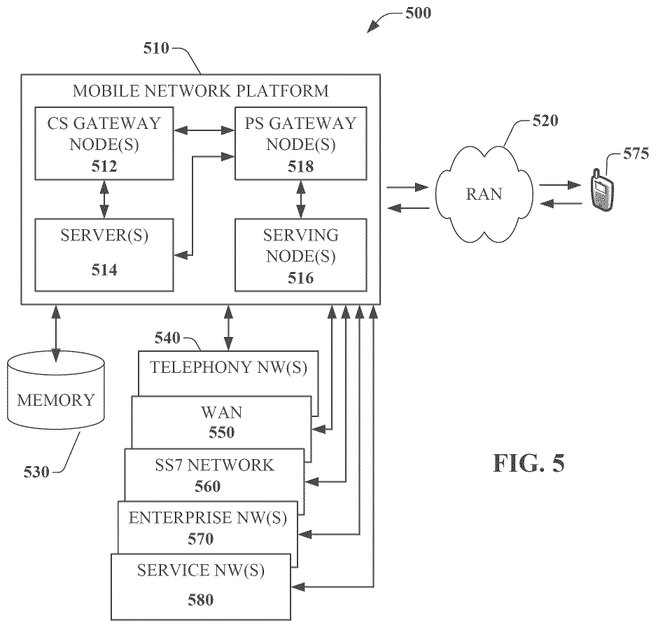

Turning now to FIG. 5, an embodiment 500 of a mobile network platform 510 is shown that is an example of systems and/or VNEs described herein. For example, platform 510 can facilitate, in whole or in part, interoperable generative AI orchestration. In one or more embodiments, the mobile network platform 510 can generate and receive signals transmitted and received by base stations or access points such as base station or access point. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology (ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

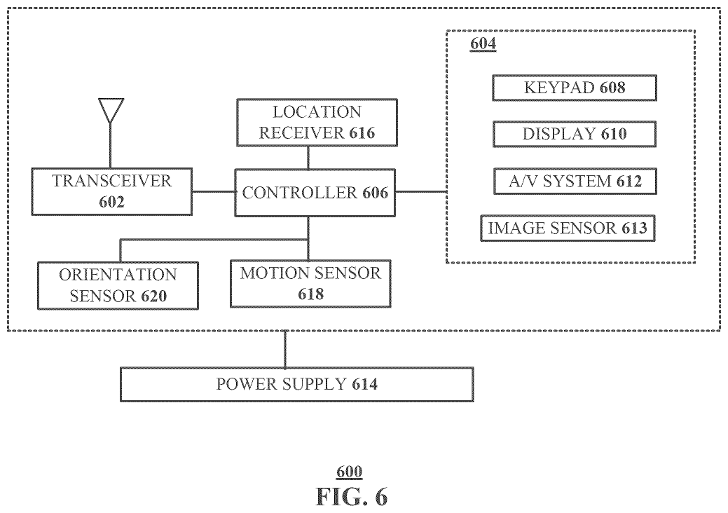

Turning now to FIG. 6, an illustrative embodiment of a communication device 600 is shown. The communication device 600 can serve as an illustrative embodiment of devices such as some or all of the systems described herein. For example, computing device 600 can facilitate, in whole or in part, interoperable generative AI orchestration.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining one or more information items or documents;
checking the one or more information items or documents for determined sensitivity and determining role-based access for the one or more information items or documents;
based on the checking and the determining, performing a preliminary analysis of the one or more information items or documents, wherein the preliminary analysis involves one or more pre-processing procedures, one or more chunking procedures, one or more embedding procedures, one or more customization procedures for particular use cases, or a combination thereof; and
storing results of the preliminary analysis in a vector knowledge base for training one or more generative artificial intelligence (AI) large language models (LLMs).

2. The device of claim 1, wherein the one or more information items or documents comprise a table or an image, and wherein the one or more pre-processing procedures comprise pre-processing of the table or the image so as to derive corresponding text or data in a particular file format that is usable by the one or more generative AI LLMs.

3. The device of claim 1, wherein the operations further comprise creating a training set to derive a predictive custom functionality or language for the one or more generative AI LLMs.

4. The device of claim 1, wherein the one or more information items or documents comprise proprietary data and relate to multiple different knowledge domains.

5. The device of claim 1, wherein the processing system is capable of further accepting supplemental information items or documents for storing and training of the one or more generative AI LLMs.

6. A method, comprising:
receiving, by a processing system including a processor, a user query, wherein the user query is submitted by an authenticated user or bot, wherein the processing system implements a plurality of processing pipelines for a corresponding plurality of content categories or classes, and wherein the processing system is interoperable with one or more generative artificial intelligence (AI) large language models (LLMs);
based on the receiving, evaluating, by the processing system, a context of the user query;
causing, by the processing system, the user query to be routed to one or more of the processing pipelines in accordance with the context;
based on the one or more of the processing pipelines to which the user query is routed, generating, by the processing system, one or more curated LLM prompts for the user query and retrieving, by the processing system, one or more extracts from one or more embeddings associated with information or documents that the one or more generative AI LLMs have been trained on;
combining, by the processing system, the one or more curated LLM prompts and the one or more extracts with the user query, resulting in a modified query; and
performing, by the processing system, response generation by submitting the modified query to the one or more generative AI LLMs that correspond to the one or more of the processing pipelines to which the user query has been routed, so as to derive a generated answer to the user query.

7. The method of claim 6, wherein the one or more generative AI LLMs comprise one or more publicly-available generative AI LLMs, one or more private generative AI LLMs, or a combination thereof.

8. The method of claim 6, wherein the evaluating involves determining whether the user query includes determined sensitive information, and wherein the method further comprises, based on a determination that the user query includes the determined sensitive information:
causing, by the processing system, a portion of the user query that includes the determined sensitive information to be redacted; or
rejecting, by the processing system, the user query and providing, by the processing system, a notification regarding the determined sensitive information.

9. The method of claim 6, wherein the performing the response generation involves ensuring that the generated answer is included in content that is used to derive the generated answer, thereby avoiding output of an answer that is derived based on LLM hallucination.

10. The method of claim 6, wherein the evaluating is performed in combination with role-based access control so as to facilitate routing of the user query to the one or more of the processing pipelines.

11. The method of claim 6, further comprising:
determining, by the processing system, that the user or the bot is not authorized to access content associated with the user query; and
generating and outputting, by the processing system, one or more recommendations to the user or the bot to obtain access to that content.

12. The method of claim 6, further comprising:
based on receiving a plurality of user queries associated with a plurality of roles, determining and outputting, by the processing system, one or more recommendations to a system administrator to reduce access restrictions for certain roles.

13. The method of claim 6, further comprising:
confirming, by the processing system, that the generated answer does not violate one or more legal policies or rights, one or more privacy-related policies, one or more ethics-related policies, one or more bias-related policies, one or more obscenity-related policies, or a combination thereof.

14. The method of claim 6, further comprising:
facilitating, by the processing system, reinforcement learning based on user feedback regarding the generated answer or based on other feedback regarding one or more other generated answers to improve answer accuracy.

15. The method of claim 6, wherein the performing the response generation further involves utilization of one or more predictive custom functionalities or languages derived for the one or more generative AI LLMs that correspond to the one or more of the processing pipelines to which the user query has been routed.

16. A non-transitory machine-readable medium, comprising executable instructions that, when executed by a processing system including a processor, facilitate performance of operations, the operations comprising:
obtaining a user query, wherein the user query is submitted by an authenticated user or bot, wherein the processing system implements a plurality of processing pipelines for a corresponding plurality of content categories or classes, and wherein the processing system is interoperable with one or more generative artificial intelligence (AI) large language models (LLMs);
based on the obtaining, evaluating a context of the user query;
causing the user query to be routed to one or more of the processing pipelines in accordance with the context;
based on the one or more of the processing pipelines to which the user query is routed, generating one or more curated LLM prompts for the user query and retrieving one or more extracts from one or more embeddings associated with information or documents that the one or more generative AI LLMs have been trained on;
combining the one or more curated LLM prompts and the one or more extracts with the user query, resulting in a modified query; and
performing response generation by submitting the modified query to the one or more generative AI LLMs that correspond to the one or more of the processing pipelines to which the user query has been routed, so as to derive a response to the user query.

17. The non-transitory machine-readable medium of claim 16, wherein the one or more generative AI LLMs comprise one or more publicly-available generative AI LLMs, one or more private generative AI LLMs, or a combination thereof.

18. The non-transitory machine-readable medium of claim 16, wherein the performing the response generation involves ensuring that the response is included in content that is used to derive the response, thereby avoiding output of a response that is derived based on LLM hallucination.

19. The non-transitory machine-readable medium of claim 16, wherein the evaluating is performed in combination with role-based access control so as to facilitate routing of the user query to the one or more of the processing pipelines.

20. The non-transitory machine-readable medium of claim 16, wherein the operations further comprise:
based on receiving a plurality of user queries associated with a plurality of roles, determining and outputting one or more recommendations to a system administrator to reduce access restrictions for certain roles.
